(19) United States
(12) Patent Application Publication
(10) Pub. No.: US 2012/0097602 A1
(43) Pub. Date: Apr. 26, 2012

(54) BIODEGRADABLE OR COMPOSTABLE BEVERAGE FILTER CARTRIDGE

(75) Inventor: RICHARD A. TEDFORD, Loveland, OH (US)

(73) Assignee: INTERNATIONAL PAPER COMPANY, Memphis, TN (US)

(21) Appl. No.: 13/234,531

(22) Filed: Sep. 16, 2011

Related U.S. Application Data
(60) Provisional application No. 61/405,845, filed on Oct. 22, 2010.

(51) Int. Cl. B01D 24/00

(52) U.S. Cl. 210/500.1

(57) ABSTRACT

A biodegradable beverage filter cartridge having: a biodegradable fluid permeable beverage filter component; an openable lid component of biodegradable and/or recyclable material; and a beverage receptacle component composed of an exterior biodegradable heat-resistant structural polymer layer, an inner protective seal layer of biodegradable polymer, and an intermediate biodegradable and/or recyclable oxygen barrier layer between the exterior and inner layers and provided with a pierceable and/or a liquid permeable base portion and a sidewall portion extending generally upwardly from the base portion for securing the lid component to the beverage receptacle component and defining a beverage filter component receptacle area for receiving the beverage filter component. The cartridge may optionally include beverage material positioned within a beverage material receiving area of the beverage filter component.

### FIELD OF THE INVENTION

The present invention broadly relates to biodegradable beverage filter cartridges having: a biodegradable liquid permeable beverage filter component; an openable lid component which comprises biodegradable or recyclable material; and a beverage receptacle component comprising an exterior biodegradable heat-resistant structural polymer layer, an inner protective seal layer comprising a biodegradable polymer, and an intermediate biodegradable and/or recyclable oxygen barrier layer between the exterior and inner layers and having a pierceable and/or a liquid permeable base portion and a sidewall portion extending generally upwardly from the base portion for securing the lid component to the beverage receptacle component and defining a beverage filter component receptacle area for receiving the filter component. The present invention further relates broadly to a biodegradable beverage filter cartridges which further includes beverage material positioned within a beverage material receiving area of the beverage filter component.

### BACKGROUND

There are a number of schemes for providing devices for making a single serve beverage product, such as, for example, a cup of coffee or tea. In one approach, a disposable container may be fitted on top of a cup and may be provided with a compartment for receiving a beverage extract such as coffee with a large reservoir on top into which a person pours boiling water. These devices may be disposable but may also be expensive. In addition, the coffee may be exposed to the air where it may easily get stale or contaminated.

Some of these devices may not be suitable for automatic coffee making or other beverage machines. Since the flow rate of beverage may be slow, these devices may be large relative to the volume of beverage dispensed. In addition, because these devices may be designed to be used upright, only the bottom area may be available for filtration flow and thus contributing to the slowness of the filtration process.

In another construction of such a device, a beverage filter may be provided in a sealed receptacle, but intermediate the receptacle and filter may also be provided a support member which functions to support the filter. When the beverage filter is wetted it may sag and conform to the support member which has a hole, opening, aperture, etc., in it to release the filtered beverage but otherwise blocks the output of the filter. Such a filter design, when used in a manner where water is injected under pressure, may provide low flow rates.

### SUMMARY

According to a first broad aspect of the present invention, there is provided a device comprising a biodegradable beverage filter cartridge, the cartridge having:
a biodegradable liquid permeable beverage filter component;
an openable lid component which comprises biodegradable and/or recyclable material; and
a beverage receptacle component comprising an exterior biodegradable heat-resistant structural polymer layer, an inner protective seal layer of a biodegradable polymer, and an intermediate biodegradable and/or recyclable oxygen barrier layer between the exterior and inner layers;
wherein the beverage receptacle component has:
   a pierceable and/or a liquid permeable base portion; and
   a sidewall portion extending generally upwardly from the base portion for securing the lid component to the beverage receptacle component and defining a filter component receptacle area for receiving the filter component.

According to a second broad aspect of the present invention, there is provided a device comprising a biodegradable beverage filter cartridge, the cartridge having:
a biodegradable liquid permeable beverage filter component having a beverage material receiving area;
beverage material positioned within the beverage material receiving area;
an openable lid component which comprises biodegradable and/or recyclable material; and
a beverage receptacle component comprising an exterior biodegradable heat-resistant structural polymer layer, an inner protective seal layer of a biodegradable polymer, and an intermediate biodegradable and/or recyclable oxygen barrier layer between the exterior and inner layers;
wherein the beverage receptacle component has:
   a pierceable and/or a liquid permeable base portion; and
   a sidewall portion extending generally upwardly from the base portion for securing the lid component to the beverage receptacle component and defining a filter component receptacle area for receiving the filter component.

### BRIEF DESCRIPTION OF THE DRAWINGS

The invention will be described in conjunction with the accompanying drawings, in which:

FIG. 1 is an exploded perspective view showing the various components of an embodiment of a beverage filter cartridge device according to the present invention;

FIG. 2 is a perspective view of the beverage filter cartridge device of FIG. 1 in an assembled configuration;

FIG. 3 is a side sectional view illustrating a three-layer compositional structure for a beverage receptacle component according to an embodiment of the present invention;

FIG. 4 is a side sectional view illustrating a four-layer compositional structure for a beverage receptacle component according to an embodiment of the present invention;

FIG. 5 is a side sectional view illustrating a five-layer compositional structure for a beverage receptacle component according to an embodiment of the present invention; and

FIG. 6 is a side sectional view illustrating a two-layer compositional structure for a lid component according to an embodiment of the present invention.

### DETAILED DESCRIPTION

It is advantageous to define several terms before describing the invention. It should be appreciated that the following definitions are used throughout this application.

### Definitions

Where the definition of terms departs from the commonly used meaning of the term, applicant intends to utilize the definitions provides below, unless specifically indicated.

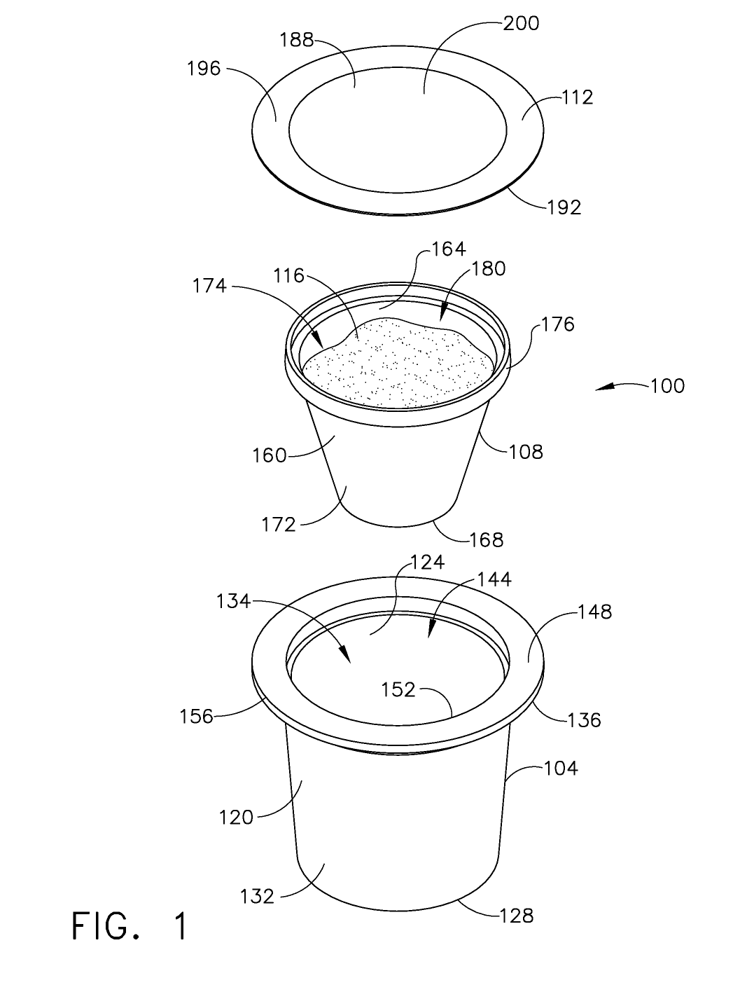

For the purposes of the present invention, directional or positional terms such as “top”, “bottom”, “upper,” “lower,” “side,” “front,” “frontal,” “forward,” “rear,” “rearward,” “back,” “trailing,” “above,” “below,” “left,” “right,” “horizontal,” “vertical,” “upward,” “downward,” “outer,” “inner,” “exterior,” “interior,” “intermediate,” etc., are merely used for convenience in describing the various embodiments of the present invention. For example, the orientation of the embodiments shown in FIGS. 1-6 may be reversed or flipped over, rotated by 90° in any direction, etc.

For the purposes of the present invention, the term “biodegradable” refers to any organic material, composition, compound, polymer, etc., which may be broken down into organic substances by living organisms, for example, microorganisms, and includes the term “compostable.”

For the purposes of the present invention, the term “compostable” refers to an organic material, composition, compound, polymer, etc., which undergoes degradation by biological processes during composting to yield, for example, carbon dioxide, water, inorganic compounds, biomass, etc., and which may leave no visible, distinguishable, toxic, etc., residue. Compostable materials may satisfy one or more of the following criteria: (1) disintegration (i.e., the ability to fragment into non-distinguishable pieces after screening and safely support bio-assimilation and microbial growth; (2) inherent biodegradation by conversion of carbon to carbon dioxide to the level of at least about 60% over a period of 180 days as measured by the ASTM D6400-04 test method; (3) safety (i.e., no evidence of any eco-toxicity in finished compost and soils can support plant growth); and (4) non-toxicity (i.e., heavy metal concentrations are less than about 50% of regulated values in soils). The compostability of materials, compositions, compounds, polymers, etc., used in embodiments of the present invention may be measured by ASTM D6400-04 test method, which is a standard test for determining compostability and which is herein incorporated by reference.

For the purposes of the present invention, the term “composting” refers to a process (e.g., managed process) which controls the biological decomposition and transformation of biodegradable materials into a humus-like substance called compost: the aerobic mesophilic and thermophilic degradation of organic matter to make compost; the transformation of biologically decomposable material through a controlled process of biooxidation which proceeds through mesophilic and thermophilic phases and results in the production of, for example, carbon dioxide, water, minerals, and stabilized organic matter (compost or humus).

For the purposes of the present invention, the term “biodegradable polymer” refers to any polymer which may be broken down into organic substances by living organisms, for example, microorganisms, and includes the term “compostable polymer.” Biodegradable polymers may include one or more of the following: one or more of: polyhydroxyalkanoates (PHAs), including polylactic acid or polylactide (PLA), as well as co-polymers of PLA and PHAs other than PLA; starch-based polymers; cellulose-based polymers; ethylene vinyl alcohol (EVOH) polymers; other biodegradable polymers such as polybutanediolsuccinic acid (PBS); etc.

For the purposes of the present invention, the term “renewable polymer” (also known as “biopolymer”) refers to a polymer, or a combination (e.g., blend, mixture, etc.) of polymers, which may be obtained from renewable natural resources, e.g., from raw or starting materials which are or may be replenished within a few years (versus, for example, petroleum which requires thousands or millions of years). For example, a renewable polymer may include a polymer that may be obtained from renewable monomers, polymers which may be obtained from renewable natural sources (e.g., starch, sugars, lipids, corn, sugar beet, wheat, other, starch-rich products etc.) by, for example, enzymatic processes, bacterial fermentation, other processes which convert biological materials into a feedstock or into the final renewable polymer, etc. See, for example, U.S. Pat. App. No. 20060036062 (Ramakrishna et al.), published Feb. 16, 2006, the entire disclosure and contents of which is hereby incorporated by reference. Renewable polymers which may be useful in embodiments of the present invention may include one or more of: polyhydroxyalkanoate (PHA) polymers; polycaprolactone (PCL) polymers; starch-based polymers; cellulose-based polymers, etc.

For the purposes of the present invention, the term “recyclable” refers to any material, composition, compound, polymer, etc., which may be reused, reprocessed, reincorporated, etc., wholly or partially, and may include organic materials (e.g., polymers) and/or metallic materials (e.g., metallic foil such as aluminum foil).

For the purposes of the present invention, the term “regrind” refers to recycled trimmed polymer that has been reground for inclusion (wholly or partially) in the layers comprising, for example, the beverage receptacle component.

For the purposes of the present invention, the term “amorphous” refers to a solid which is not crystalline, i.e., has no lattice structure which is characteristic of a crystalline state.

For the purposes of the present invention, the term “crystalline” refers to a solid which has a lattice structure which is characteristic of a crystalline state.

For the purposes of the present invention, the term “high temperature deformation-resistant material” refers to a material which resists deformation at a temperature of about 140° F. (60° C.) or higher, for example, about 150° F. (65.6° C.) or higher.

For the purposes of the present invention, the term “high temperature deformable material” refers to a material which deforms at a temperature of less than about 140° F. (60° C.), for example, less than about 130° F. (54.4° C.).

For the purposes of the present invention, the term “thermoforming” refers to a method for preparing a shaped, formed, etc., article, layer, element, component, etc., from a thermoplastic sheet, film, etc. In thermoforming, the sheet, film, etc., may be heated to its melting or softening point, stretched over or into a temperature-controlled, single-surface mold and then held against the mold surface until cooled (solidified). The formed article, layer, element, component, etc., may then be trimmed from the thermoformed sheet. The trimmed material may be reground, mixed with virgin plastic, and reprocessed into usable sheet. Thermoforming may include vacuum forming, pressure forming, twin-sheet forming, drape forming, free blowing, simple sheet bending, etc.

For the purposes of the present invention, the term “thermoform” and similar terms such as, for example “thermoformed,” etc., refers to articles, layers, elements, components, etc., made by a thermoforming method.

For the purposes of the present invention, the term “melting point” refers to the temperature range at which a crystalline material changes state from a solid to a liquid, e.g., may be molten. While the melting point of material may be a specific temperature, it often refers to the melting of a crystalline material over a temperature range of, for example, a few degrees or less. At the melting point, the solid and liquid phase of the material often exist in equilibrium.

For the purposes of the present invention, the term “Tₘ” refers to the melting temperature of a material, for example, a polymer. The melting temperature is often a temperature range at which the material changes from a solid state to a liquid state. The melting temperature may be determined by using a differential scanning calorimeter (DSC) which determines the melting point by measuring the energy input needed to increase the temperature of a sample at a constant rate of temperature change, and wherein the point of maximum energy input determines the melting point of the material being evaluated.

For the purposes of the present invention, the term “softening point” refers to a temperature or range of temperatures at which a material is or becomes shapeable, moldable, formable, deformable, bendable, extrudable, etc. The term softening point may include, but does not necessarily include, the term melting point.

For the purposes of the present invention, the term “Tₛ” refers to the Vicat softening point (also known as the Vicat Hardness). The Vicat softening point is measured as the temperature at which a polymer specimen is penetrated to a depth of 1 mm by a flat-ended needle with a 1 sq. mm circular or square cross-section. A load of 9.81 N is used. Standards for measuring Vicat softening points for thermoplastic resins may include JIS K7206, ASTM D1525 or ISO306, which are incorporated by reference herein.

For the purposes of the present invention, the term “T_{g}” refers to the glass transition temperature. The glass transition temperature is the temperature: (a) below which the physical properties of amorphous materials vary in a manner similar to those of a solid phase (i.e., a glassy state); and (b) above which amorphous materials behave like liquids (i.e., a rubbery state).

For the purposes of the present invention, the term “heat deflection temperature (HDT)” or heat distortion temperature (HDTUL) (collectively referred to hereafter as the “heat distortion index (HDI)”) is the temperature at which a polymer deforms under a specified load. HDI is a measure of the resistance of the polymer to deformation by heat and is the temperature (in ° C.) at which deformation of a test sample of the polymer of predetermined size and shape occurs when subjected to a flexural load of a stated amount. HDI may be determined by following the test procedure outlined in ASTM D648, which is herein incorporated by reference. ASTM D648 is a test method which determines the temperature at which an arbitrary deformation occurs when test samples are subjected to a particular set of testing conditions. This test provides a measure of the temperature stability of a material, i.e., the temperature below which the material does not readily deform under a standard load condition. The test sample is loaded in three-point bending device in the edgewise direction. The outer fiber stress used for testing is 1.82 MPa, and the temperature is increased at 2° C./min until the test sample deflects 0.25 mm.

For the purposes of the present invention, the term “melt flow index (MFI)” (also known as the “melt flow rate (MFR)) refers to a measure of the ease of flow of the melt of a thermoplastic polymer, and may be used to determine the ability to process the polymer in thermoforming MFI may be defined as the weight of polymer (in grams) flowing in 10 minutes through a capillary having a specific diameter and length by a pressure applied via prescribed alternative gravimetric weights for alternative prescribed temperatures. Standards for measuring MFI include ASTM D1238 and ISO 1133, which are herein incorporated by reference. The testing temperature used is 190° C. with a loading weight of 2.16 kg. For thermoforming according to embodiments of the present invention, the MFI of the polymers may be in the range from 0 to about 20 grams per 10 minutes, for example from 0 to about 15 grams per 10 minutes.

For the purposes of the present invention, the terms “viscoelasticity” and “elastic viscosity” refer interchangeably to a property of materials which exhibit both viscous and elastic characteristics when undergoing deformation. Viscous materials resist shear flow and strain linearly with time when a stress is applied, while elastic materials strain instantaneously when stretched and just as quickly return to their original state once the stress is removed. Viscoelastic materials have elements of both of these properties and, as such, exhibit time dependent strain. Whereas elasticity is usually the result of bond stretching along crystallographic planes in an ordered solid, viscoelasticity is the result of the diffusion of atoms or molecules inside of an amorphous material.

For the purposes of the present invention, the term “hydroxy aliphatic acids” refers to organic aliphatic carboxylic acids having a hydroxy group, and which may be used to provide polyhydroxyalkanoates. Hydroxy aliphatic acids useful herein may include one or more of: lactic acid; hydroxy-beta-butyric acid (also known as hydroxy-3-butyric acid); hydroxy-alpha-butyric acid (also known as hydroxy-2-butyric acid); 3-hydroxypropionic acid; 3-hydroxyvaleric acid; 4-hydroxybutyric acid; 4-hydroxyvaleric acid; 5-hydroxyvaleric acid; 3-hydroxyhexanoic acid; 4-hydroxyhexanoic acid; 6-hydroxyhexanoic acid; hydroxyacetic acid (also known as glycolic acid); lactic acid (also known as hydroxy-alpha-propionic acid); malic acid (also known as hydroxysuccinic acid), etc.

For the purposes of the present invention, the term “polyhydroxyalkanoates (PHAs)” refers broadly to renewable, biodegradable, thermoplastic aliphatic polyesters which may be produced by polymerization of the respective monomer hydroxy aliphatic acids (including dimers of the hydroxy aliphatic acids), by bacterial fermentation of starch, sugars, lipids, etc. PHAs may include one or more of: poly-beta-hydroxybutyrate (PHB) (also known as poly-3-hydroxybutyrate); poly-alpha-hydroxybutyrate (also known as poly-2-hydroxybutyrate); poly-3-hydroxypropionate; poly-3-hydroxyvalerate; poly-4-hydroxybutyrate; poly-4-hydroxyvalerate; poly-5-hydroxyvalerate; poly-3-hydroxyhexanoate; poly-4-hydroxyhexanoate; poly-6-hydroxyhexanoate; polyhydroxybutyrate-valerate (PHBV); polyglycolic acid; polylactic acid (PLA), etc., including copolymers, blends, mixtures, combinations, etc., of different PHA polymers, etc. PHAs may be synthesized by methods disclosed in, for example, U.S. Pat. No. 7,267,794 (Kozaki et al.), issued Sep. 11, 2007; U.S. Pat. No. 7,276,361 (Doi et al.), issued Oct. 2, 2007; U.S. Pat. No. 7,208,535 (Asrar et al.), issued Apr. 24, 2007; U.S. Pat. No. 7,176,349 (Dhugga et al.), issued Feb. 13, 2007; and U.S. Pat. No. 7,025,908 (Williams et al.), issued Apr. 11, 2006, the entire disclosure and contents of the foregoing documents being herein incorporated by reference.

For the purposes of the present invention, the term “polylactic acid or polylactide (PLA)” refers to a renewable, biodegradable, thermoplastic, aliphatic polyester formed from a lactic acid or a source of lactic acid, for example, renewable resources such as corn starch, sugarcane, etc. The term PLA may refer to all stereoisomeric forms of PLA including L- or D-lactides, and racemic mixtures comprising L- and D-lactides. For example, PLA may include D-polylactic acid, L-polylactic acid (also known as PLLA), D,L-polylactic acid, meso-polylactic acid, as well as any combination of D-polylactic acid, L-polylactic acid, D,L-polylactic acid and meso-polylactic acid. PLAs useful herein may have, for example, a number average molecular weight in the range of from about 15,000 and about 300,000. In preparing PLA, bacterial fermentation may be used to produce lactic acid, which may be oligomerized and then catalytically dimerized to provide the monomer for ring-opening polymerization. PLA may be prepared in a high molecular weight form through ring-opening polymerization of the monomer using, for example, a stannous octanoate catalyst, tin(II) chloride, etc.

For the purposes of the present invention, the term “starch-based polymer” refers to a polymer, or combination of polymers, which may be derived from, prepared from, etc., starch. Starch-based polymers which may be used in embodiments of the present invention may include, for example, polylactic acid (PLA), thermoplastic starch (for example, by mixing and heating native or modified starch in the presence of an appropriate high boiling plasticizer, such as glycerin and sorbitol, in a manner such that the starch has little or no crystallinity, a low T_{g}, and very low water, e.g., less than about 5% by weight, for example, less than about 1% water), plant starch (e.g., cornstarch), etc., or combinations thereof. See, for example, starch-based polymers, such as plant starch, disclosed in published PCT Pat App. No. 2003/051981 (Wang et al.), published Jun. 26, 2003, the entire disclosure and contents of which are hereby incorporated by reference, etc.

For the purposes of the present invention, the term “cellulose-based polymer” refers to a polymer, or combination of polymers, which may be derived from, prepared from, etc., cellulose. Cellulose-based polymers which may be used in embodiments of the present invention may include, for example, cellulose esters, such as cellulose formate, cellulose acetate, cellulose diacetate, cellulose propionate, cellulose butyrate, cellulose valerate, mixed cellulose esters, etc., and mixtures thereof

For the purposes of the present invention, the term “mineral filler” refers to inorganic materials, often in particulate form, which may lower cost (per weight) of the polymer, and which, at lower temperatures, may be used to increase the stiffness and decrease the elongation to break of the polymer, and which, at higher temperatures, may be used to increase the viscosity of the polymer melt. Mineral fillers which may used in embodiments of the present invention may include, for example, talc, calcium chloride, titanium dioxide, clay, synthetic clay, gypsum, calcium carbonate, magnesium carbonate, calcium hydroxide, calcium aluminate, magnesium carbonate mica, silica, alumina, sand, gravel, sandstone, limestone, crushed rock, bauxite, granite, limestone, glass beads, aerogels, xerogels, fly ash, fumed silica, fused silica, tabular alumina, kaolin, microspheres, hollow glass spheres, porous ceramic spheres, ceramic materials, pozzolanic materials, zirconium compounds, xonotlite (a crystalline calcium silicate gel), lightweight expanded clays, perlite, vermiculite, hydrated or unhydrated hydraulic cement particles, pumice, zeolites, exfoliated rock, etc., and mixtures thereof

For the purposes of the present invention, the term “oxygen barrier layer” refers to a layer comprising a material, polymer, etc., which inhibits, limits, reduces, minimizes, prevents, etc., the diffusion, passage, transmission, etc., of oxygen through that layer, thus protecting, preserving, etc., beverage materials present in the beverage filter cartridge. For example, the oxygen barrier layer may limit the diffusion, passage, transmission, etc., of oxygen to about 0.07 cc or less per day. The oxygen barrier layer may comprise one or more of the following materials: polymers, such as ethylene vinyl alcohol (EVOH), polyamides (e.g., nylon); metallic foil, such as aluminum foil; etc.; etc.

For the purposes of the present invention, the term “protective seal layer” refers to a layer adjacent to (or potentially in adjacent to), and in contact (or potentially in contact) with the beverage material, aqueous liquid, and/or liquid beverage formed from the beverage material, and which may also protect the oxygen barrier layer from contact with aqueous liquid and/or liquid beverage formed from the beverage material, to inhibit, reduce, protect, prevent, etc., the oxygen barrier layer from being dissolved, degraded, etc., by the aqueous liquid and/or liquid beverage formed from the beverage material.

For the purposes of the present invention, the term “beverage filter component” refers to a component which is liquid permeable to an aqueous liquid beverage (e.g., aqueous liquid beverage extracts) and which separates (filters) particulate beverage materials (which may be contained, held, received, etc., by the beverage filter component) from which the aqueous liquid beverage is formed.

For the purposes of the present invention, the term “liquid permeable” refers to a material, element, component, etc., which permits liquids (e.g., aqueous liquids) to pass through.

For the purposes of the present invention, the term “beverage material” refers to materials from which aqueous liquid beverages (e.g., aqueous liquid beverage extracts) may be formed. Beverage materials may include one or more of: oxygen-sensitive beverage materials, such as extractable coffee materials (e.g., roast and ground coffee, flaked coffee, etc.); soluble (instant) coffee materials; chocolate beverage materials (e.g., cocoa powder, etc.); other beverage materials such as extractable tea materials; soluble (instant) tea materials; etc.

For the purposes of the present invention, the term “openable” refers to a lid component which is removable (wholly or partially), peelable (wholly or partially), pierceable, etc., to permit, allow, enable, etc., access to the contents, interior, etc., of the beverage filter cartridge, including permitting, enabling, allowing, etc., access by aqueous liquids (e.g., water, etc.) to permit disposal of the contents of a beverage filter cartridge (e.g., spent, extracted, etc., beverage material), etc.

For the purposes of the present invention, the term “pierceable” refers to a component, element, material, etc., which may be perforated, punctured, etc., to at least permit the passage of aqueous liquids (e.g., water, an aqueous liquid beverage, etc.) into a beverage filter cartridge and/or to permit the passage of such liquids out of the beverage filter cartridge. For example, the pierceable component, element, material, etc., may provide for sealing of the beverage filter cartridge such that the aqueous fluid (e.g., water, etc.) enters (e.g., through a pierced lid component) and comes into contact with beverage material present in the beverage filter cartridge (e.g., the beverage filter component), and thus provides a liquid beverage which may then exit from the beverage filter cartridge (e.g., through the pierced beverage receptacle component).

For the purposes of the present invention, the term “lid component” refers to a component which functions as permanent or temporary closure for a beverage filter cartridge.

For the purposes of the present invention, the term “beverage receptacle component” refers to a component for a beverage filter cartridge which receives, contains, holds, etc., at least the beverage filter component and to which the lid component is secured permanently or temporarily.

For the purposes of the present invention, the term “molded” refers to any method for casting, shaping, forming, extruding, etc., softened or melted polymers, articles, layers, elements, components, etc.

For the purposes of the present invention, the term “blow molded” refers to a method of molding in which the material is melted and extruded into a hollow tube (also referred to as a parison). This parison may then be captured by closing it into a cooled mold and air is then blown into the parison, thus inflating parison into the shaped article, layer, element, component, etc. After the shaped article has cooled sufficiently, the mold is opened and the article is released (e.g., ejected).

For the purposes of the present invention, the term “compression molded” refers to a method of molding in which the molding material, with optional preheating, is first placed in an open, heated mold cavity. The mold is closed with a top force or plug member, pressure is applied to force the material into contact with all mold areas, and heat and pressure are maintained until the molding material has cured.

For the purposes of the present invention, the term “heat-resistant layer” refers to a layer which comprises one or more heat-resistant polymers for imparting heat resistance to the layer.

For the purposes of the present invention, the term “heat-resistant polymer” refers to a polymer (or polymers) which has an HDI value of greater than about 70° C., for example, about 75° C., e.g., in the range of from about 76° to about 100° C. (from about 170° to about 212° F.). In other words, these heat-resistant polymers are resistant to deformation at temperatures above about 70° C., for example, above about 75° C., e.g., in the range of from about 76° to about 100° C. (from about 170° to about 212° F.). These heat-resistant polymers may include one or more of: biodegradable polyolefins (e.g., polyethylene, polypropylene, etc.), biodegradable polyesters (e.g., polylactic acid (PLA), polyhydroxyalkanoates (PHAs) other than PLA, such as polyhydroxybutyrate-valerate (PHBV), polybutanediolsuccinic acid (PBS), aromatic-aliphatic polyester copolymers which have been randomly crosslinked as with organic peroxide or electron beam irradiation in the presence of glycidyl methacrylate to provide a polymer which can withstand beverage (e.g., coffee brewing temperatures in the range of from about 76° to about 100° C. (from about 170° to 212° F.)), biodegradable polyamides, biodegradable polyimides, biodegradable polyurethanes, biodegradable cellulose-based polymers, such as cellulose propionate, etc., biodegradable copolymers of such heat-resistant polymers, etc., including, for example, copolymers of polylactic acid (PLA) and polyhydroxyalkanoates (PHAs) other than PLA.

For the purposes of the present invention, the term “structural polymer layer” refers to a layer comprising a heat-resistant polymer which provides sufficient rigidity such that the layer, for example, may be pierced, yet substantially maintain the shape of the beverage filter cartridge when exposed to temperatures above about 70° C. (e.g., hot water during the brewing process of, for example, coffee). For example, the heat-resistant structural polymer provides a structural support in the beverage receptacle component, for example, during a (e.g., coffee) brewing process so that the oxygen barrier layer (e.g., EVOH), and interior polymer seal layer do not deform while the brewing process is occurring.

For the purposes of the present invention, the term “sheet” refers to webs, strips, films, pages, pieces, segments, etc., which may be continuous in form (e.g., webs) for subsequent subdividing into discrete units, or which may be in the form of discrete units (e.g., pieces).

For the purposes of the present invention, the term “extrusion” refers to a method for shaping, molding, forming, etc., a material by forcing, pressing, pushing, etc., the material through a shaping, forming, etc., device having an orifice, slit, etc., for example, a die, etc. Extrusion may be continuous (producing indefinitely long material) or semi-continuous (producing many short pieces, segments, etc.).

For the purposes of the present invention, the term “coextrusion” and similar terms, such as, for example, “coextruded,” refers to refers to the extrusion of multiple layers of material (e.g., polymers) simultaneously. Coextrusion may utilize two or more extruders to melt and deliver a steady volumetric throughput of different molten materials to a single extrusion head which may combine the materials in the desired extruded shape.

For the purposes of the present invention, the term “interpenetrating network” refers to where two adjacent areas, domains, regions, layers, etc., merge, combine, unite, fuse, etc., together so that there is essentially no boundary therebetween.

For the purposes of the present invention, the term “thermoplastic” refers to the conventional meaning of thermoplastic, i.e., a composition, compound, material, etc., that exhibits the property of a material, such as a high polymer, that softens when exposed to sufficient heat and generally returns to its original condition when cooled to room temperature.

For the purposes of the present invention, the term “plasticizer” refers to the conventional meaning of this term as an agent which softens a polymer, thus providing flexibility, durability, etc. Plasticizers may be advantageously used in amounts of, for example, from about 0.01 to about 45% by weight, e.g., from about 3 to about 15% by weight of the polymer, although other concentrations may be used to provide desired flexibility, durability, etc. Plasticizers which may used in embodiments of the present invention include, for example, one or more of: aliphatic carboxylic acids; aliphatic carboxylic acid metal salts; aliphatic esters; aliphatic amides; alkyl phosphate esters; dialkylether diesters; dialkylether esters; tricarboxylic esters; epoxidized oils and esters; polyesters; polyglycol diesters; alkyl alkylether diesters; aliphatic diesters; alkylether monoesters; citrate ester, dicarboxylic esters; vegetable oils and their derivatives; esters of glycerine; ethers, etc. For example, with starch-based polymers (e.g., plant starch), the plasticizers may include one or more aliphatic acids (e.g., oleic acid, linoleic acid, stearic acid, palmitic acid, adipic acid, lauric acid, myristic acid, linolenic acid, succinic acid, malic acid, cerotic acid, etc.), one or more low molecular weight aliphatic polyesters, one or more aliphatic amides (e.g., oleamide, stearamide, linoleamide, cycle-n-lactam, ε-caprolactam, lauryl lactam, N,N-dibutyl stearamide, N,N-dimethyl oleamide, etc.), one or more aliphatic carboxylic acid esters (e.g., methoxyethyl oleate, diisooctyl sebacate, bis(2-butoxyethyl) adipate, dibenzyl sebacate, isooctyl- isodecyl adipate, butyl epoxy fatty acid ester, epoxidized butyl acetoricinoleate, and low molecule weight (300-1200) poly(1,2-propylene glycol adipate, etc.), one or more aliphatic carboxylic acid metal salts (e.g., magnesium oleate, ferrous oleate, magnesium stearate, ferrous stearate, calcium stearate, zinc stearate, magnesium stearate, zinc stearate pyrrolidone, etc.) See published PCT Pat App. No. 2003/051981 (Wang et al.), published Jun. 26, 2003, the entire disclosure and contents of which are hereby incorporated by reference.

For the purposes of the present invention, the term “compatibilizer” refers to a composition, compound, etc., used to enhance reextrusion of polymer(s), plastic trim, etc., in thermoforming recycle operations by causing what may be two or more dissimilar polymers to provide a homogeneous, or more homogeneous, melt during reextrusion, and to avoid or minimize disassociation when recycled material is added back to the polymer feedstock being extruded. Compatibilizers which may be used in embodiments of the present invention include, for example, biodegradable polyolefins, such as polybutadienes, etc., modified with maleic anhydride, citrates of fatty acids, glycerol esters, etc. The compatibilizer may be advantageously used in amounts from about 0.005 to about 10% by weight, for example from about 0.01 to about 5% by weight of the polymer, although other concentrations may be used so long as they are effective at keeping the two or more polymers miscible and more homogeneous. Maleated polyolefins/polybutadienes/polystyrenes are commercially available compatibilizers, sold by Eastman (EPOLENES®), Crompton (POLYBONDS®), Honeywell (A-C®), and Sartomer (Ricons®). Maleated and epoxidized rubbers, derived from natural rubbers, may also be useful as compatibilizers, for example, maleic anhydride grafted rubber, epoxy/hydroxyl functionalized polybutadiene, etc. Other carboxylic acid modified polyolefin copolymers, such as those from succinic anhydride, may also be used. Monomers such as maleic anhydride, succinic anhydride, etc., may also be added directly along with or without other commercial compatibilizers to prepare in situ compatabilized blends. See U.S. Pat. No. 7,256,223 (Mohanty et al.), issued Aug. 14, 2007, the entire disclosure and contents of which is hereby incorporated by reference. Other useful compatibilizers may include poly(2-alkyl-2-oxazolines), such as, for example, poly(2-ethyl-2-oxazoline) (PEOX), poly(2-propionyl-2-oxazoline), poly(2-phenyl-2-oxazolone), etc. See U.S. Pat. No. 6,632,923 (Zhang et al.), issued Oct. 14, 2003, the entire disclosure and contents of which is hereby incorporated by reference. These compatibilizers may be included singly or as combinations of compatibilizers. For example, with starch-based polymers (e.g., plant starch), the compatibilizers may include one or more products (or complexes) of co-monomers and anhydrides (or their derivatives) at, for example, a 1:1 mole ratio), wherein the co-monomer may include one or more of: acrylonitrile, vinyl acetate, acrylamide, acrylic acid, glutaric acid, methacrylate, styrene, etc., and wherein the anhydride (or derivative) may include one or more of: acetic anhydride, methacrylic acid anhydride, succinic anhydride, maleic anhydride, maleimide, etc. See published PCT Pat App. No. 2003/051981 (Wang et al.), published Jun. 26, 2003, the entire disclosure and contents of which are hereby incorporated by reference.

For the purposes of the present invention, the term “mil(s)” is used in the conventional sense of referring to thousandths of an inch.

### DESCRIPTION

An example of a disposable device for making a single-serve beverage is a beverage filter cartridge, such as disclosed in, for example, U.S. Pat. No. 5,325,765 (Sylvan et al.), issued Jul. 5, 1994 (hereafter referred to as the “'765 patent”). This beverage filter cartridge may include an impermeable pierceable base having a predetermined shape and an opening at one end. This beverage filter cartridge may also include a self-supporting liquid permeable filter element disposed in the base which sealingly engages with the opening in the base and has a form different and smaller than that of the predetermined shape of the base so that the filter element diverges from the base and divides the base into two sealed chambers. The first chamber may store an extract of the beverage to be made, while the second empty chamber may access the beverage after the beverage outflow from the filter element has been made by combining a liquid with the extract. This beverage filter cartridge may also include an impermeable pierceable cover which is sealingly engaged with the opening in the base such that cartridge is impermeable.

Disposable (e.g., single-serve) beverage generating devices, such as the beverage filter cartridges disclosed in, for example, the '765 patent, may create significant issues in terms of recyclability, impact on the environment, etc., depending upon what materials, polymers, etc., are used in the various components, layers, etc., these disposable devices are constructed from. In particular, these devices, when disposed of in large quantities, may provide a significant impact on the environment in terms of landfills, etc. In response, such devices, and the respective components, layers, etc., thereof may be constructed of materials, polymers, etc., which may be biodegradable (including being compostable) and/or recyclable, to make such disposable devices more “eco-friendly.” But the biodegradable materials, polymers, etc., which may be used to construct the respective components, layers, etc., thereof may need to have the ability to provide structural integrity and heat-resistance in the presence of hot liquids, oxygen barrier protection, protection from and/or resistance against dissolving, degradation, etc., in the presence of (hot) aqueous liquids, etc.

Embodiments of the present invention broadly include a biodegradable beverage filter cartridge. The cartridge includes a biodegradable and liquid permeable beverage filter component. The cartridge also includes an openable lid component which comprises biodegradable and/or recyclable material. The cartridge further includes a beverage receptacle component comprising an exterior biodegradable heat-resistant structural polymer layer, an inner protective seal layer comprising a biodegradable polymer, and an intermediate biodegradable and/or recyclable oxygen barrier layer between the exterior and inner layers. This beverage receptacle component has: a pierceable and/or a liquid permeable base portion; and a sidewall portion extending generally upwardly from the base portion for securing the lid component to the beverage receptacle component and defining a filter component receptacle area for receiving the filter component. The cartridge may also optionally include beverage material positioned within a beverage material receiving area of the beverage filter component.

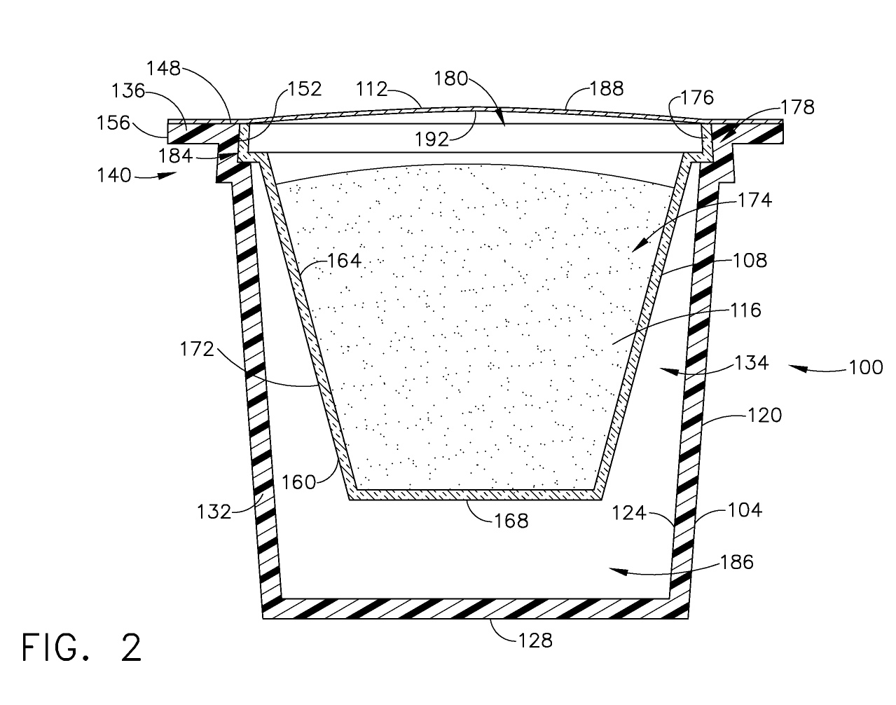

A biodegradable beverage filter cartridge may be provided, for example, in the configuration described in the '765 patent, the entire disclosure and contents of which is herein incorporated by reference. Referring to the drawings of the instant application, FIGS. 1 and 2 show an embodiment of one such biodegradable beverage filter cartridge, indicated generally as 100. Cartridge 100 comprises a generally cup-shaped beverage receptacle component, indicated generally as 104, a liquid permeable beverage filter component, indicated generally as 108, (which is shown in FIG. 2 as fitting within cup-shaped component 104), and a pierceable and/or peelable lid component, indicated generally as 112 (which is shown in FIG. 1 as having a generally circular shape). Cartridge 100 may also be optionally provided with beverage material, indicated generally as 116, which sits or rests within (e.g., is contained by) filter component 108.

As particularly shown in FIG. 2, cup-shaped component 104 has an exterior surface 120 and an interior surface 124. Cup-shaped component 104 also has a generally circular base portion 128, and a generally cylindrical sidewall portion 132 extending generally from base portion 128 and defining an inner generally cylindrical filter component and liquid beverage receptacle area 134 of cup-shaped component 104. Sidewall portion 132 includes a lip portion 136 at upper end 140 of sidewall portion 132 which defines a generally circular-shaped opening 144 for cup-shaped component 104. Lip portion 136 includes an upper generally annular surface 148 proximate to opening 144, and having an inner circumferential edge 152 adjacent opening 144 and an outer circumferential edge 156 spaced outwardly from inner edge 152.

Filter component 108 has an outer surface 160 and an inner beverage material-contacting surface 164. Filter component 108 is also shown in FIGS. 1 and 2 as comprising a generally circular base portion 168 and a generally frustoconically-shaped sidewall 172 which extends generally upwardly and outwardly from base portion 168 and which defines an inner beverage material receptacle area 174. Sidewall 172 also includes an upper lip portion 176 at its upper end 178 which defines a generally circular opening 180. As shown in FIG. 2 in particular, lip portion 176 of filter component 108 has a generally L-shaped cross-section such that outer surface 160 fits within and rests against a generally L-shaped shoulder 184 of inner surface 124 of lip portion 136 of cup-shaped component 104. As also shown in FIG. 2, filter component 108, sidewall 132 and base portion 128 define a liquid beverage receptacle area, indicated generally as 186, outside of surface 160 and generally below base portion 168 of filter component 108 within cup-shaped component 104.

Lid component 112 comprises an outer surface 188 and an inner surface 192. Lid component 112 also comprises a generally circular inner body portion 196 and a generally annular edge portion 200. As shown in FIG. 2, edge portion 200 of lid component 112 is secured to annular upper surface 148 of lip portion 136 of sidewall 132 of cup-shaped component 104 such that lid component 112 may be, in some embodiments, peelable from cup-shaped component 104, but may be, in other embodiments, non-peelable from cup-shaped component 104.

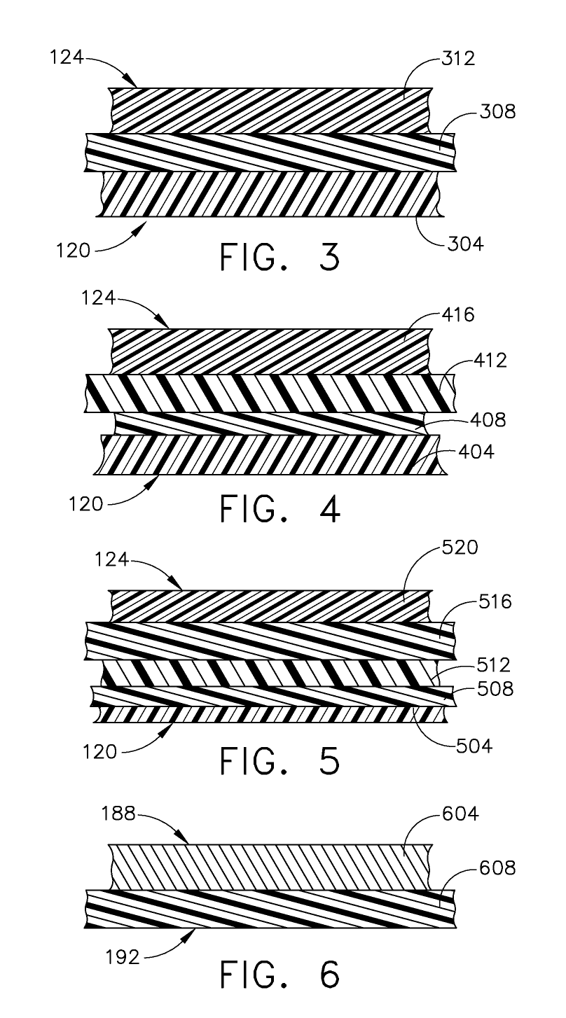

FIGS. 3 through 5 illustrate several different embodiments of the compositional structure for each layer of cup-shaped component 104 (which also indicate which layer includes exterior surface 120 and which layer includes interior surface 124). FIG. 3 illustrates a three-layer compositional structure (e.g., a three-layer laminate) for cup-shaped component 104. Exterior layer 304 (which includes exterior surface 120) may comprise, for example, a thermally (heat)-resistant biodegradable (e.g., compostable) polymer such as a biodegradable polyester (e.g., polylactic acid (PLA) or a randomly cross linked PLA-polyhydroxyalkanoate (PHA) other than PLA copolymer. Adjacent exterior layer 304 is an intermediate oxygen barrier layer 308 which may comprise, for example, a compostable ethylene vinyl copolymer (EVOH). Adjacent intermediate layer 308 is an interior protective seal layer 312 (which includes interior surface 124) which may comprise, for example, a biodegradable (e.g., compostable) polyester (e.g., PLA). As shown in FIG. 3, intermediate layer 308 is positioned or sandwiched between exterior layer 304 and interior layer 312.

FIG. 4 illustrates a four-layer compositional structure (e.g., a four-layer laminate) for cup-shaped component 104. Exterior layer 404 (which includes exterior surface 120) may comprise, for example, a thermally resistant biodegradable (e.g., compostable) polymer, such as a biodegradable polyester (e.g., like layer 304). Adjacent exterior layer 404 is a first intermediate oxygen barrier layer 408 which may comprise, for example, a compostable ethylene vinyl alcohol copolymer (EVOH) (e.g., like layer 308). Adjacent first intermediate layer 408 is a second intermediate layer 412 which may comprise, for example, a biodegradable (e.g., compostable) trim regrind polymer (e.g., polyester) and which is positioned. Adjacent second intermediate layer 412 is an interior protective seal layer 416 (which includes interior surface 124) which may comprise, for example, a biodegradable (e.g., compostable) polymer, such as a biodegradable polyester (e.g., like layer 308). As shown in FIG. 4, intermediate layers 408 and 412 are positioned or sandwiched between exterior layer 404 and interior protective seal layer 416, with intermediate layer 412 also being positioned or sandwiched between intermediate layer 408 and interior protective seal layer 416.

FIG. 5 illustrates a five-layer compositional structure (e.g., a five-layer laminate) for cup-shaped component 104. Exterior layer 504 (which includes exterior surface 120) may comprise, for example, a thermally resistant biodegradable (e.g., compostable) polymer, such as a biodegradable polyester (e.g., like layers 304 and 404). Adjacent exterior layer 504 is a first intermediate oxygen barrier layer 508 which may comprise, for example, a compostable ethylene vinyl copolymer (EVOH) (e.g., like layers 308 and 408). Adjacent first intermediate layer 508 is a second intermediate layer 512 which may comprise, for example, a biodegradable (e.g., compostable) polymer (e.g., polyester) and/or trim regrind polymer (e.g., polyester). Adjacent second intermediate layer 512 is a third intermediate layer 516 which may comprise a biodegradable (e.g., compostable) trim regrind polymer, such as a trim regrind polyester (e.g., like layer 412). Adjacent third intermediate layer 516 is an interior protective seal layer 520 (which includes interior surface 124) which may comprise, for example, a biodegradable (e.g., compostable) polymer, such as a biodegradable polyester (e.g., like layers 312 and 416). As shown in FIG. 5, intermediate layers 508, 512, and 516 are positioned or sandwiched between exterior layer 504 and interior seal layer 516, with intermediate layer 512 also being positioned or sandwiched between intermediate layer 508 and intermediate layer 516, while intermediate layer 516 is positioned or sandwiched between intermediate layer 512 and interior protective seal layer 416.

Because of regulatory requirements (e.g., those proscribed by the Food & Drug Administration (FDA) for interior protective seal layers 312/416/520 which may be in contact with an aqueous (and “hot”) liquid beverage (e.g., brewed coffee), these interior layers may have reduced structural integrity such that cup-shaped component 104 might collapse, fold up, crumple, etc. As a result, exterior layers 304/404/504 included in the compositional structure of cup-shaped component 104 comprise heat-resistant structural polymers to provide greater structural integrity and strength to cup-shaped component 104 in the presence of such aqueous (and “hot”) liquid beverages. Intermediate oxygen barrier layers 308/408/508 positioned between interior layers 312/416/520 and exterior layers 304/404/504 provide protection of beverage material 116 (e.g., oxygen-sensitive beverage materials, such as extractable coffee materials (e.g., roast and ground coffee, flaked coffee, etc.); soluble (instant) coffee materials; chocolate beverage materials (e.g., cocoa powder, etc.) against oxidation, degradation, staling, etc., but may also be vulnerable to being dissolved, degraded, etc., by the aqueous liquid and/or liquid beverage formed from beverage material 116. Accordingly, interior protective seal layers 312/416/520 may provide an additional benefit of to inhibit, reduce, protect, prevent, etc., such dissolving, degradation, etc., of intermediate oxygen barrier layers 308/408/508.

FIG. 6 illustrates a two-layer compositional structure for lid component 112. Upper layer 604 (which includes outer surface 1 may comprise, for example, either a recyclable metallic foil (e.g., aluminum) or a biodegradable (e.g., compostable) heat-resistant polymer. Lower layer 608 (which includes inner surface 192 which is secured, for example, by being adhesively adhered to upper annular surface 148 of lip portion 136 of cup-shaped component 104) may comprise, for example, either a low temperature (i.e., non-heat-resistant) biodegradable (e.g., compostable) polymer (for example, when upper layer 604 comprises a biodegradable (e.g., compostable) heat-resistant polymer), or a biodegradable (e.g., compostable) heat-resistant polymer (for example, when upper layer 604 comprises a metallic foil). In some embodiments, when lid component 112 comprises an upper metallic foil layer 604, lid component 112 may be pierceable, and also, non-peelable from cup-shaped component 104. In some embodiments, when lid component 112 comprises an upper metallic foil layer 604, lower layer 608 may comprise a relatively thin adhesive (e.g., thermoplastic polymer heat seal) layer which may, or may not (e.g., ethylene vinyl acetate (EVA) or ethylene methacrylic acid (such as Nucrel)), comprise biodegradable (e.g., compostable) polymers, which has an affinity for (e.g., adherence to) upper metallic foil layer 604, and which adheres lid component 112 to upper surface 148 of cup-shaped component 104. In some embodiments, when lid component 112 comprises a laminate of an upper layer 604 comprising a biodegradable (e.g., compostable) heat-resistant polymer and a lower layer 608 comprising a low temperature (i.e., non-heat-resistant) biodegradable polymer, lid component 112 may be non-pierceable, but also, peelable (openable) from cup-shaped component 104.

Embodiments of filter component 108 may comprise a compostable mixture of cellulose fibers and compostable polyester fibers, or solely compostable polyester fibers, for example, from 0 to about 60% (such as from about 40 to about 60%) cellulose fibers, and from about 40 to 100% (such as from about 40 to about 60%) compostable polyester fibers, such as compostable polylactic acid (PLA) fibers. Embodiments of filter component 108 which comprise mixtures cellulose fibers and PLA may be adhered to other biodegradable polyesters, such as a grafted copolymer of polylactic acid and polyhydroxyalkanoate, Natureworks 4060D (an amorphous grade of polylactic acid sold/distributed by Natureworks LLC), etc. Some embodiments of filter element 108 may be comprised of compostable polyester fibers, such as Natureworks 4042d polyester and cellulose fibers, such that the polyester fiber component is about 20% or higher by mass of filter component 108.

In some embodiments of lid component 112, a biodegradable polyester, such as Natureworks 4060D, may be adhered directly to an aluminum foil upper layer 604 with enough strength to provide a lower hermetic seal layer 608. By using aluminum foil upper layer 604 having a thickness greater than about 0.5 mils (e.g., such as from about 0.5 to about 70 mils), it may also be possible to remove upper layer 604 after using cartridge 100 so that used cartridge 100 may be disposed of in a composting facility. In some embodiments of lid component 112 comprising a laminate film of an upper layer 604 comprising a compostable heat-resistant polyester with a lower layer 608 comprising a low temperature polyester seal layer, such as Natureworks 4060D (a polylactic acid (PLA) polymer, may provide a lid component 112 which does not have to be removed (e.g., peeled from surface 148 of cup-shaped component 104) prior to disposal in a composting facility. In some embodiments of lid component 112, upper layer 604 may comprise aluminum foil having a thickness of, for example, from about 0.23 to about 70 mils (e.g., from about 0.23 to about 1 mils such as about 0.5 mils) with a lower seal coating layer 608 of at least about 1 mil of a PLA (e.g., 4060D PLA resin). Such lower polyester seal layers 604 may comprise other biodegradable polyesters besides PLA, such as other polyhydroxyalkanoates (PHAs), for example, polyhydroxybutyrate-valerate (PHBV), polybutanediolsuccinic acid (PBS), as well as aromatic-aliphatic polyester copolymers which are thermoplastic. In some embodiments of filter component 108, these polyester seal layers may also be adhered to the non-cellulose fibers of filter component 108.

In some embodiments of cup-shaped component 104, exterior layer 304 may comprise a biodegradable thermally resistant, randomly cross linked polylactic acid (PLA)-polyhydroxyalkanoate (PHA) other than PLA copolymer having a thickness of, for example, from about 5 to about 20 mils thickness, an intermediate oxygen barrier layer 308 comprising ethylene vinyl alcohol (EVOH) having a thickness of, for example, from about 2 to about 10 mils, and an interior surface layer 312 comprising PLA (e.g., Natureworks 4060D) of having a thickness of, for example, from about 2 to about 30 mils thickness.

All documents, patents, journal articles and other materials cited in the present application are hereby incorporated by reference.

Although the present invention has been fully described in conjunction with several embodiments thereof with reference to the accompanying drawings, it is to be understood that various changes and modifications may be apparent to those skilled in the art. Such changes and modifications are to be understood as included within the scope of the present invention as defined by the appended claims, unless they depart therefrom.

What is claimed is:

1. A device, comprising a biodegradable beverage filter cartridge, the cartridge having:
a biodegradable liquid permeable beverage filter component;
an openable lid component which comprises biodegradable and/or recyclable material; and
a beverage receptacle component comprising an exterior biodegradable heat-resistant structural polymer layer, an inner protective seal layer of a biodegradable polymer, and an intermediate biodegradable and/or recyclable oxygen barrier layer between the exterior and inner layers;
wherein the beverage receptacle component has:
a pierceable and/or a liquid permeable base portion; and
a sidewall portion extending generally upwardly from the base portion for securing the lid component to the beverage receptacle component and defining a filter component receptacle area for receiving the filter component.

2. The device of claim 1, wherein the exterior layer comprises a biodegradable heat-resistant polyester, wherein the inner layer comprises a biodegradable polyester, and wherein the intermediate oxygen barrier layer comprises a compostable ethylene vinyl alcohol copolymer.

3. The device of claim 2, wherein the exterior layer comprises one or more compostable heat-resistant polyhydroxyalkanoates, and wherein the inner layer comprises one or more compostable polyhydroxyalkanoates.

4. The device of claim 2, wherein the polyhydroxyalkanoates comprise one or more of: poly-beta-hydroxybutyrate; poly-alpha-hydroxybutyrate; poly-3-hydroxypropionate; poly-3-hydroxyvalerate; poly-4-hydroxybutyrate; poly-4-hydroxyvalerate; poly-5-hydroxyvalerate; poly-3-hydroxyhexanoate; poly-4-hydroxyhexanoate; poly-6-hydroxyhexanoate; polyhydroxybutyrate-valerate; polyglycolic acid; or polylactic acid.

5. The device of claim 4, wherein the exterior layer comprises a compostable heat-resistant polylactic acid, a compostable heat-resistant polyhydroxyalkanoate other than polylactic acid, or a compostable heat-resistant copolymer of polylactic acid and a polyhydroxyalkanoate other than polylactic acid, and wherein the inner layer comprises a compostable polylactic acid.

6. The device of claim 2, wherein the exterior layer has a thickness of from about 5 to about 20 mils thickness; wherein the intermediate oxygen barrier layer has a thickness of from about 2 to about 10 mils, and wherein the interior layer has a thickness of from about 2 to about 30 mils.

7. The device of claim 2, wherein the beverage receptacle component comprises a second intermediate layer comprising a biodegradable polyester which is positioned between the intermediate oxygen barrier layer and the interior protective seal layer.

8. The device of claim 2, wherein the beverage receptacle component comprises a second intermediate layer comprising a biodegradable polyester and/or trim regrind polyester and a third intermediate layer comprising a biodegradable polyester, wherein the second intermediate layer is positioned between the intermediate oxygen barrier layer and the third intermediate layer, and wherein the third intermediate layer is positioned between the second intermediate layer and the interior protective seal layer.

9. The device of claim 1, wherein the base portion of the beverage receptacle component is pierceable.

10. The device of claim 1, wherein the base portion of the beverage receptacle component is liquid permeable.

11. The device of claim 1, wherein the beverage receptacle component is generally cup-shaped.

12. The device of claim 11, wherein the sidewall portion and the base portion define filter component, sidewall portion and the base portion define a liquid beverage receptacle area within the beverage receptacle component.

13. The device of claim 11, wherein the sidewall portion has an upper end and a lip portion at the upper end defining a generally circular-shaped opening, the lip portion including an upper generally annular surface proximate the opening for securing the lid component to the beverage receptacle component.

14. The device of claim 11, wherein the lid component has an upper layer comprising a biodegradable heat-resistant polyester, and a lower layer comprising a biodegradable polyester which is adhered to the upper surface of the lip portion.

15. The device of claim 11, wherein the lid component has an upper layer comprising metallic foil and a lower layer which is adhered to the upper surface of the lip portion.

16. The device of claim 15, wherein the metallic foil has a thickness of from about 0.23 to about 1 mils.

17. The device of claim 15, wherein the metallic foil comprises aluminum foil.

18. The device of claim 11, wherein the lid component is peelable from the upper surface of the lip portion.

19. The device of claim 1, wherein the lid component is pierceable.

20. The device of claim 1, wherein the filter component comprises a compostable mixture of from 0 to about 60% cellulose fibers and from about 40 to 100% compostable polyester fibers.

21. A device comprising a biodegradable beverage filter cartridge, the cartridge having:
a biodegradable liquid permeable beverage filter component having a beverage material receiving area;
beverage material positioned within the beverage material receiving area;
an openable lid component which comprises biodegradable and/or recyclable material; and
a beverage receptacle component comprising an exterior biodegradable heat-resistant structural polymer layer, an inner protective seal layer comprising a biodegradable polymer, and an intermediate biodegradable and/or recyclable oxygen barrier layer between the exterior and inner layers;
wherein the beverage receptacle component has:
a pierceable and/or liquid permeable base portion; and
a sidewall portion extending generally upwardly from the base portion for securing the lid component to the beverage receptacle component and defining a filter component receptacle area for receiving the filter component.

22. The device of claim 21, wherein the beverage material comprises coffee material.

23. The device of claim 22, wherein the coffee material comprises extractable coffee material.

24. The device of claim 23, wherein the extractable coffee material comprises roast and ground coffee.

25. The device of claim 21, wherein the exterior layer comprises a biodegradable heat-resistant polyester, wherein the inner layer comprises a biodegradable polyester, and wherein the intermediate oxygen barrier layer comprises a compostable ethylene vinyl alcohol copolymer.

26. The device of claim 25, wherein the exterior layer comprises one or more compostable heat-resistant polyhydroxyalkanoates, and wherein the inner layer comprises one or more compostable polyhydroxyalkanoates.

27. The device of claim 26, wherein the polyhydroxyalkanoates polymer comprise one or more of: poly-beta-hydroxybutyrate; poly-alpha-hydroxybutyrate; poly-3-hydroxypropionate; poly-3-hydroxyvalerate; poly-4-hydroxybutyrate; poly-4-hydroxyvalerate; poly-5-hydroxyvalerate; poly-3-hydroxyhexanoate; poly-4-hydroxyhexanoate; poly-6-hydroxyhexanoate; polyhydroxybutyrate-valerate; polyglycolic acid; or polylactic acid.

28. The device of claim 27, wherein the exterior layer comprises a compostable heat-resistant polylactic acid, a compostable heat-resistant polyhydroxyalkanoate other than polylactic acid, or a compostable heat-resistant copolymer of polylactic acid and a polyhydroxyalkanoate other than polylactic acid, and wherein the inner layer comprises a compostable polylactic acid.

29. The device of claim 25, wherein the exterior layer has a thickness of from about 5 to about 20 mils thickness; wherein the intermediate oxygen barrier layer has a thickness of from about 2 to about 10 mils, and wherein the interior layer has a thickness of from about 2 to about 30 mils.

30. The device of claim 25, wherein the beverage receptacle component comprises a second intermediate layer comprising a biodegradable polyester which is positioned between the intermediate oxygen barrier layer and the interior protective seal layer.

31. The device of claim 25, wherein the beverage receptacle component comprises a second intermediate layer comprising a biodegradable polyester and/or trim regrind polyester and a third intermediate layer comprising a biodegradable polyester, wherein the second intermediate layer is positioned between the intermediate oxygen barrier layer and the third intermediate layer, and wherein the third intermediate layer is positioned between the second intermediate layer and the interior protective seal layer.

32. The device of claim 24, wherein the base portion of the beverage receptacle component is pierceable.

33. The device of claim 24, wherein the base portion of the beverage receptacle component is liquid permeable.

34. The device of claim 24, wherein the beverage receptacle component is generally cup-shaped.

35. The device of claim 34, wherein the sidewall portion and the base portion define filter component, sidewall portion and the base portion define a liquid beverage receptacle area within the beverage receptacle component.

36. The device of claim 35, wherein the sidewall portion has an upper end and a lip portion at the upper end defining a generally circular-shaped opening, the lip portion including an upper generally annular surface proximate the opening for securing the lid component to the beverage receptacle component.

37. The device of claim 34, wherein the lid component has an upper layer comprising a biodegradable heat-resistant polyester, and a lower layer comprising a biodegradable polyester which is adhered to the upper surface of the lip portion.

38. The device of claim 34, wherein the lid component has an upper layer comprising metallic foil and a lower layer which is adhered to the upper surface of the lip portion.

39. The device of claim 38, wherein the metallic foil has a thickness of from about 0.23 to about 1 mils.

40. The device of claim 38, wherein the metallic foil comprises aluminum foil.

41. The device of claim 34, wherein the lid component is peelable from the upper surface of the lip portion.

42. The device of claim 24, wherein the lid component is pierceable.

43. The device of claim 24, wherein the filter component comprises a compostable mixture of from 0 to about 60% cellulose fibers and from about 40 to 100% compostable polyester fibers.
